(19) United States
(12) Patent Application Publication
(10) Pub. No.: US 2004/0242157 A1
(43) Pub. Date: Dec. 2, 2004

(54) Device and method for supressing periodic interference signals

(76) Inventor: Stefano Ambrosius Klinke, Kerpen (DE)

Correspondence Address: Bell Boyd & Lloyd, Three First National Plaza, 70 West Madison Street, Suite 3300, Chicago, IL, 60602-4207, US

(21) Appl. No.: 10/491,054

(22) PCT Filed: Sep. 28, 2001
(86) PCT No.: PCT/DE01/03727

(51) Int. Cl. H04B 15/00

(52) U.S. Cl. 455/63.1; 455/114.2

(57) ABSTRACT

The invention relates to a device and method for suppressing periodic interference signals, comprising a signal analyser (1), for the output of an error signal (d(k)) and corresponding coefficients (aᵢ) on the basis of a distorted wanted signal (x(k)), whereby a suppression unit (2) generates a suppressing error signal (d(k)), based on the error signal (d′(k)) and a signal synthesiser (3) regenerates a recovered wanted signal (x*(k)), based on the suppressing error signal (d′(k)) and the coefficients aᵢ.

The present invention relates to a device and a method for suppressing periodic interference signals, and in particular to a device and a method for suppressing periodic interference in the audio frequency domain, which interference is caused, for example, by a digital telecommunications system when data is transmitted, and is input, for example, into a mobile telecommunications terminal or an external terminal such as, for example, a hearing aid device.

In a large number of digital telecommunications systems, data is transmitted between a mobile telecommunications terminal, for example, a mobile phone, and an associated base station by means of a pulsed radio frequency signal with a predetermined carrier frequency. For what is referred to as a GSM telecommunications system (Global System for Mobile Communications), the carrier frequency is 900 megahertz and a pulse frequency is approximately 217 Hz. In contrast, in the case of a DECT telecommunications system, the carrier frequency is 1800 megahertz and the associated pulse frequency is 100 Hz. A further standard which is based on GSM is the DCS 1800 Standard which also operates with a carrier frequency of 1800 megahertz. In the case of digital telecommunications systems, a large number of carrier frequencies with different pulse frequencies are therefore used for which reason the manufacturers of terminals are increasingly developing what are referred to as dual band or triple band terminals for implementing the various standards.

In particular, the pulsed radio frequency signal often creates problems in this context. The pulsed radio frequency signal is demodulated, for example, by the nonlinear FET characteristic curve of a microphone which is present in the terminal, and in this way gives rise to significantly perceptible interference in the audio frequency domain in some cases.

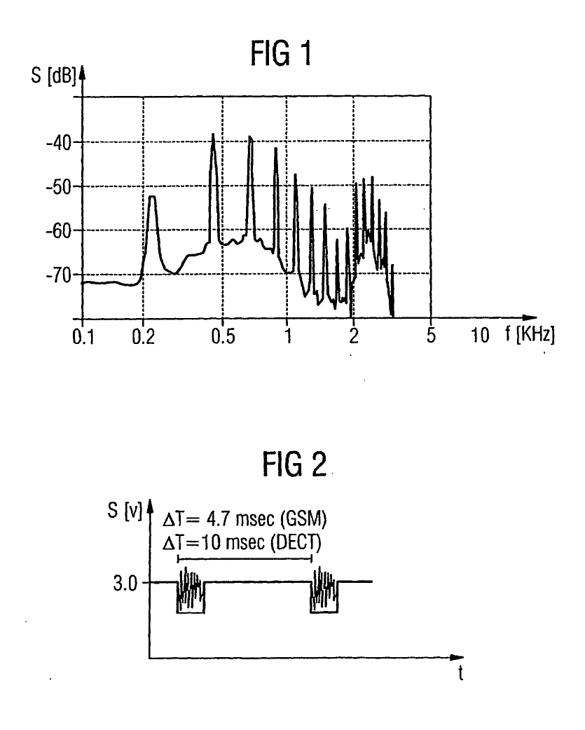

FIG. 1 shows a simplified representation of an interference spectrum such as is emitted at the output of a signal source, for example a microphone, which has been subjected to interference by such a pulsed radio frequency signal.

FIG. 2 shows a simplified representation of the associated pulsed radio frequency signal or periodic interference signal, such as occurs, for example, in GSM or DECT telecommunications systems. In the GSM standard according to FIG. 2, radio frequency pulses which contain the actual information are transmitted with a timing pattern ΔT of approximately 4.7 milliseconds. In the DECT standard, this timing pattern ΔT is 10 milliseconds and corresponds to a frequency of 100 Hz in contrast to 217 Hz in the case of GSM. These periodic interference signals can then be input into a printed circuit board, in particular at a signal source such as, for example, a microphone, as a result of which the interference peaks represented in FIG. 1 are obtained.

Conventional devices and methods for suppressing these periodic interference signals are based essentially on shielding against the radio interference by means of, for example, a conductive shielding housing of the signal source, or of a conductive microphone housing. It is to be noted here that the housing is, as far as possible, completely closed. An optimum effect is usually brought about by metallic shielding. However, the cost of such shielding, in particular in the case of devices such as, for example, a mobile telecommunications terminal and/or a hearing aid device, are extremely costly and also take up a lot of space.

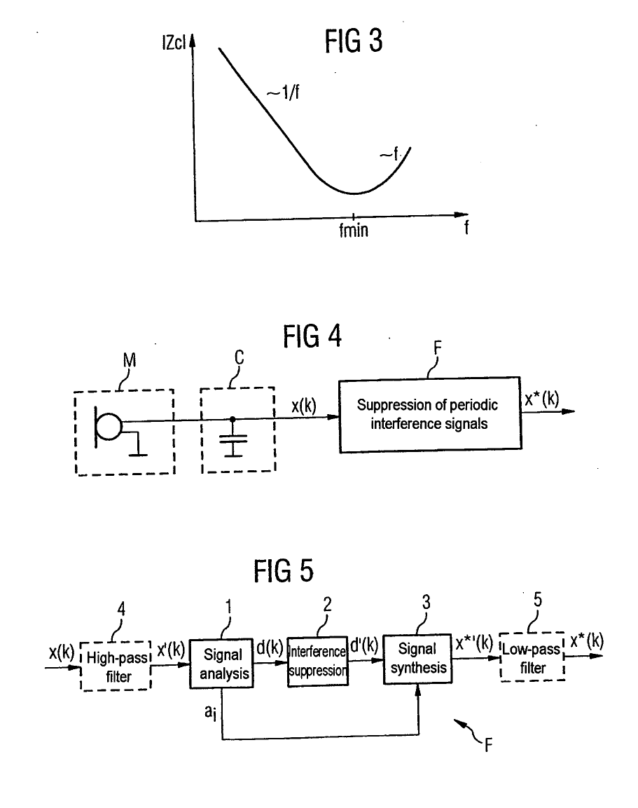

A further possible way of suppressing these periodic interference signals is usually to eliminate line-bound interference by means of filtering. In this context, interference suppressor capacitors are generally used and they are mounted near to the field effect transistor (FET) of the microphone in order to attenuate the periodic radio frequency interference signal there as much as possible. The selection of the capacitor is particularly critical here since the influence of parasitic inductances increases greatly at high frequencies, and the impedance of the capacitor has the profile illustrated in FIG. 3. Consequently, optimum interference suppression is achieved only with a capacitor whose impedance is minimal for the respective frequency of the interference signal. However, it is disadvantageous here that such signal sources or microphones which are tuned using capacitors cost significantly more than conventional standard electret microphones. In addition, new signal sources or microphones must be developed for each new telecommunications terminal or mobile phone model or else each type of hearing aid device since the hardware environment, for example, the printed circuit board layout of the terminal or of the hearing aid, influences the properties of the interference suppressor capacitor. A further disadvantage is that a respective interference suppressor capacitor is required for each carrier frequency so that for a dual band device signal sources with two interference suppressor capacitors are required, and for a triple band device signal sources with even three interference suppressor capacitors are required.

The invention is therefore based on the object of providing a device and a method for suppressing periodic interference signals, with which device and method a significant cost reduction with improved interference suppression is made possible.

According to the invention, this object is achieved with respect to the device by means of the features of patent claim 1 and with respect to the method by means of the measures of patent claim 18.

In particular by using a signal analyzer for outputting a fault signal and associated coefficients on the basis of a useful signal which has been subjected to interference, an interference suppressor unit for generating a fault signal which has been subjected to interference suppression and has reduced periodic interference signals on the basis of the fault signal and a signal synthesizer for recovering a useful signal which has been subjected to interference suppression, on the basis of the fault signal which has been subjected to interference suppression, and the coefficients, excellent suppression of periodic interference signals is obtained. The application of the interference suppressor unit to the fault signal which is generated by the signal analyzer has a particularly positive effect here on reverberation effects which are felt to be unpleasant and which would normally occur if the interference suppressor unit were applied directly to the useful signal which has been subjected to interference.

The signal analyzer is preferably composed of an FIR (Finite Impulse Response) filter for outputting a predictive fault signal and associated predictor coefficients on the basis of a voice signal, and the signal synthesizer is preferably composed of an IIR (Infinite Impulse Response) filter for recovering a voice signal which has been subjected to interference suppression, on the basis of a fault signal which has been subjected to interference suppression, and the associated coefficients. To be more precise, according to the invention, the voice estimators which are used in any case when performing voice coding in digital telecommunications systems are used for suppressing the periodic interference signals. In particular when used in mobile telecommunications terminals, the use of the voice coding elements which are already present in any case provides an extremely cost-effective way of suppressing periodic interference signals. In the same way, such elements which are known from voice coding and voice estimation can also be used in external devices such as, for example, hearing aid devices, as a result of which further miniaturization accompanied by further interference suppression is made possible, in particular with respect to the periodic interference signals which are generated by digital transmission systems. The signal analyzer is preferably composed of a linear predictor which carries out a short-term prediction in a time domain of 20 to 400 milliseconds. Since the digitized voice is generally very redundant data, i.e. the loss or the suppression of individual data items during the transmission can be tolerated within wide limits, such linear short-term predictors permit sufficiently precise fault signals and coefficients for further signal processing to be generated. In order to determine the respective coefficients it is appropriate here to use in particular what is referred to as the Levinson-Durbin algorithm since it is generally used for voice coding in particular in mobile terminals and is thus available in any case.

In addition, a high-pass filter can be used at the signal input for filtering the useful signal which has been subjected to interference and for improving the coefficient calculation in the signal analyzer, what is referred to as a preemphasis filter being generally used. The suppression of interference can also be improved further. In addition, at the signal output end it may be optional to use a low-pass filter for filtering the useful signal which has been subjected to interference suppression, and for compensating the high-pass filter which has been used at the signal input, this filter usually constituting what is referred to as a deemphasis filter.

The interference suppressor unit for generating an interference signal which has been subjected to interference suppression preferably carries out filtering in the time domain or in the frequency domain on the basis of the fault signal. The interference suppressor unit here is, for example, a comb filter with maximum attenuation values in each case in the vicinity of the fundamental frequency and the associated harmonics of the periodic interference signals.

The interference suppression device is preferably constructed in a wire-free telecommunications terminal since a large number of components are already present and the inputting of interference owing to the direct vicinity between the transmitter component and receiver component is particularly problematic. However, in the same way it may also be constructed in external devices, in particular in hearing aid devices, in which there is likewise a high degree of inputting of interference owing to the direct closeness of the terminal of the digital communications system and the external device. The cost of such hearing aid devices can thus also be reduced further with further miniaturization and protection against interference.

Further advantageous refinements of the invention are characterized in the further claims.

The invention is described below in more detail by means of exemplary embodiments and with reference to the drawing, in which:

FIG. 1 shows a simplified representation of a frequency spectrum which is generated by a signal source and has periodic interference signals;

FIG. 2 shows a simplified chronological representation of the periodic interference signal;

FIG. 3 shows a simplified graphic representation of an impedance profile which is implemented with an interference suppressor capacitor;

FIG. 4 shows a simplified block representation of an overall system with the interference suppressor device according to the invention;

FIG. 5 shows a simplified block representation of the interference suppression device according to the invention;

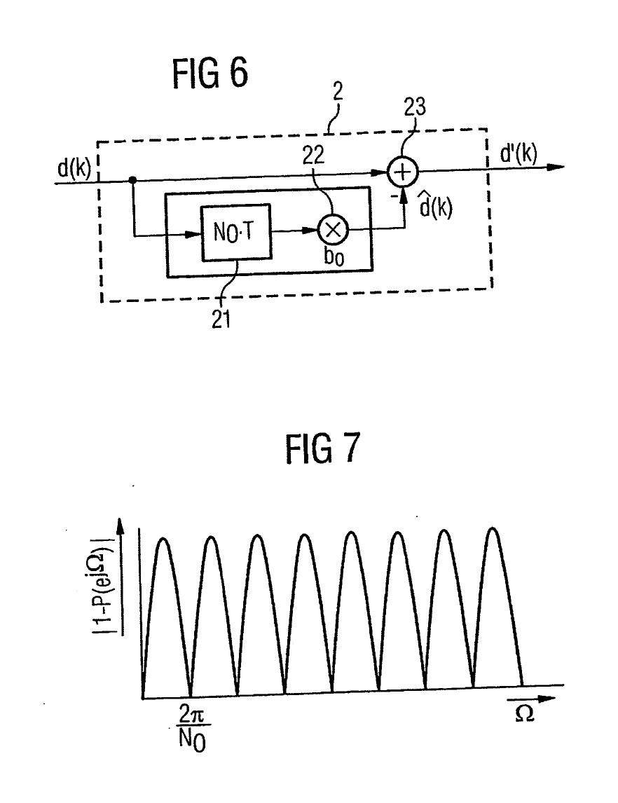

FIG. 6 shows a simplified block representation of an interference suppressor unit according to FIG. 5; and

FIG. 7 shows a simplified graphic representation of the frequency spectrum of the interference suppressor unit according to FIG. 6.

FIG. 4 shows a simplified block circuit diagram of a system configuration in which the interference suppressor device according to the invention can, for example, be used.

According to FIG. 4, M designates a signal source and a microphone for converting an acoustic voice signal into an electric voice signal or useful signal. As has already been described above, an actual voice useful signal can have an interference signal superimposed on it owing to the inputting of interference signals, for example, via the printed circuit board or via radio interference, as a result of which a useful signal x(k) which has been subjected to interference is produced. Such superimposition of a periodic interference signal on a useful signal is generally known, the humming which is caused by the power system being a typical example.

However, as has already been described at the beginning, such interference can also take place in digital telecommunications devices and devices used in the direct vicinity of these terminals, the periodic interference signal being caused in this case by the transmission of data between the mobile telecommunications terminal and the associated base station. In order to suppress such periodic interference signals, it is possible to carry out the known measures described at the beginning, for example providing shielding of the signal source M and/or providing an interference signal prefilter C which usually has a interference suppressor capacitor and is also suitable for reducing the periodic interference signal in the useful signal x(k). According to the invention, the periodic interference signals are then suppressed according to FIG. 4 in a block F, the measures which are already known for the suppression of interference being able to be optionally added to the interference suppression according to the invention.

FIG. 5 shows a simplified block representation of the interference signal suppression device F according to FIG. 4. In order to simplify the following description, it is initially assumed that the optional blocks 4 and 5 are not present in FIG. 5, and the useful signal x(k) which has been subjected to interference=x′(k). In the same way, x*′(k)=x*(k).

Essentially, the device for suppressing the periodic interference signals is composed here of a signal analyzer 1 for outputting a fault signal d(k) and associated coefficients aᵢ on the basis of the useful signal which has been subjected to interference, or an electric voice signal which has been subjected to interference. On the basis of the fault signal d(k) which has been output by the signal analyzer 1, an interference suppressor unit 2 generates a fault signal d′(k) which has been subjected to interference suppression and has reduced periodic interference signals and which is passed on to a signal synthesizer 3. The signal synthesizer 3 carries out, on the basis of the fault signal d′(k) which has been subjected to interference suppression, and the coefficients aᵢ, which have been generated by the signal analyzer 1, a signal synthesis in order to recover a useful signal x*(k) or x*′(k) which has been subjected to interference suppression. Since the interference suppression is applied to a fault signal which is generated during the signal analysis, and not to the actual useful signal x(k) or x′(k) which has been subjected to interference, what are referred to as reverberation effects, which are felt to be unpleasant, are reliably avoided, and given suitable adaptation of the interference suppressor unit 2 to the periodic interference signal, interference suppression without loss of the useful signal quality is carried out. The useful signal quality of the useful signal x*(k) which has been subjected to interference suppression can accordingly be significantly improved.

First Exemplary Embodiment

According to a first exemplary embodiment, the interference suppression device is constructed in a mobile telecommunications terminal such as, for example, a mobile phone, the elements which are represented in FIG. 5 being already present for implementing voice coding, at least in some cases.

Digitized voice usually involves very redundant data. In order to reduce a quantity of data, and susceptibility to interference, use is therefore made, in particular in wire-free telecommunications systems, of what are referred to as voice coders which improve signal quality or immunity to interference while taking into account the reception capabilities of humans.

Here, what are referred to as voice estimators FIR (Finite Impulse Response) filters and/or an IIR filter for outputting a predictive fault signal and associated predictor coefficients are generated on the basis of a voice signal which is present. According to the invention, the signal analyzer 1 can then use such an FIR filter for outputting a predictive fault signal d(k) and associated predictor coefficients aᵢ on the basis of the voice signal x(k) in question, which has been subjected to interference. In this context, a linear predictor for carrying out a linear prediction may be used for example, as a signal analyzer 1, a short-term prediction being preferably carried out in a time domain from 20 to 400 milliseconds. Such linear short-term predictors—preferably what is referred to as the Leavisson-Durbin algorithm is used for calculating the predictor coefficients a₁—are again generally known in voice coding, for which reason a detailed description is not given below.

The signal analyzer 1 accordingly generates a fault signal d(k) which has been subjected to interference, and associated coefficients aᵢ which contain no interference.

According to FIG. 5, the actual interference suppression of the periodic interference signal is then carried out in the interference suppressor unit 2, it being possible to use, for example, the comb filter which is represented in FIG. 6.

The fault signal which is generated by the signal analyzer 1 is composed essentially of the difference between the useful signal x(k) which has been subjected to interference and an associated estimated value \hat{x}(k), i.e. d(k)=x(k)−\hat{x}(k). According to FIG. 6, the periodic interference signals are then removed from the fault signal d(k) by means of adapted noise reduction. The suppression of the interference components can be carried out according to many methods and with filtering in the time domain and in the frequency domain. In what follows, only one possible method with which a periodic interference signal can be suppressed is represented by way of example.

The periodic interference components in the frequency domain are caused by a periodic time signal with a specific fundamental frequency (see FIGS. 1 and 2). If N₀ is the period length of the interference signal, an improved fault signal d′(k), or a fault signal d′(k) which has been subjected to at least partial interference suppression, is calculated according to the following formula:

d′(k)=d(k)−b₀×d(k−N₀),

d(k) representing the fault signal which has been subjected to interference, and d′(k) representing the improved fault signal, or fault signal which has been subjected to at least partial interference suppression. For example, this is a comb filter with maximum attenuation values, in each case in the vicinity of the fundamental frequency and the associated harmonics of the periodic interference signal. The maximum attenuation values can be controlled by the coefficient b₀, in which case when b₀ is equal to 0 the interference components are not attenuated, whereas, in contrast, when b₀ is equal to 1, maximum possible attenuation is brought about.

The factor b₀ can be controlled here in such a way that the maximum attenuation values remain small in the presence of a useful signal. If, in contrast, the useful signal is not present, the maximum attenuation values can reach their maximum value. A simple method for implementing the control of the factor b₀ is obtained from the formula:

$${b}_{0} = \frac{{\sum }_{k = {k}_{1}}^{k - {k}_{0}} d ( k ) d ( k - {N}_{0} )}{{\sum }_{k = {k}_{1}}^{k = {k}_{0}} {d}^{2} ( k - {N}_{0} )}$$

According to FIG. 6, the interference suppressor unit 2 is accordingly performed by a delay element 21 where N₀T, T being the time interval of the periodic interference signal, a multiplier 22 for multiplying by the factor b₀ and an adder 23 for implementing the difference between the estimated fault signal \hat{d}(k) and the incoming fault signal d(k).

FIG. 7 shows a simplified graphic representation of the frequency profile of the comb filter represented in FIG. 6.

As has already been mentioned in the introduction to the description, not only one periodic interference signal but also a plurality of periodic interference signals may occur, in particular in the case of dual band and triple band devices. In contrast to the conventional filtering by means of capacitors, interference suppression is possible with extraordinary ease according to the invention since the interference suppressor unit 2 now only have further factors b₁, b₂, . . . and associated period lengths N₁, N₂, . . . . In a general form the following formula is consequently obtained for the improved fault signal d′(k):

d′(k)=d(k)−b₀×d(k−N₀)−b₁×d(k−N₁)− . . . ,

the associated factors b₁, b₂, etc. being calculated in the same way as the factor b₀.

In the present exemplary embodiment, particularly cost-effective interference suppression can consequently be implemented, in particular, in the case of what are referred to as dual band and triple band terminals, using components which are present in any case.

The improved fault signal d′(k) or fault signal d′(k) which is at least partially subjected to interference suppression, is then synthesized in conjunction with the coefficients aᵢ, as a result of which the useful signal or original signal x*(k) which has been subjected to interference suppression is obtained.

In order to improve the coefficient calculation in the signal analyzer 1 further, it is possible, according to FIG. 5, also to use at the input end a high-pass filter 4 for additional high-pass filtering of the useful signal x(k) which has been subjected to interference, and to generate a useful signal x′(k) which has been filtered but still has interference. What is referred to as a preemphasis filter is generally used as a high-pass filter 4, said filter bringing about further improvement in conjunction with the signal analyzers used from voice coding. In order to compensate the optionally introduced high-pass filter 4 it is also optionally possible to use a low-pass filter 5 at the output end for low-pass filtering of the useful signal x*′(k) which has been subjected to interference suppression and which finally outputs the useful signal x*(k) which has been subjected to interference suppression. Such a low-pass filter is generally composed of what is referred to as a deemphasis filter.

In the same way, the known interference suppression prefilters C as well as shielding of the signal source M can in turn be optionally added to the described interference signal suppression device according to FIG. 5, then resulting in the use of cost-effective electret microphones. The interference suppressor capacitors C would have to be mounted here directly at the connecting pins of the signal source or of the microphone M. The advantage of the method described above or the device described above is consequently that possible artifacts in the useful signal which may arise owing to a conventional noise reduction can be significantly attenuated by the signal analysis and signal synthesis.

Second Exemplary Embodiment

According to a further exemplary embodiment, the device, according to the invention and the associated method are not integrated into a system which generates the periodic signal but rather implemented as an external device. Such external devices may represent, in particular, what are referred to as hearing aid devices since they are usually used in the direct vicinity of a respective mobile telecommunications terminal and are thus particularly subjected to interference from periodic interference signals described above. To be more precise, the interference signal suppression device described above is accordingly implemented in a hearing aid device which can represent, for example, a behind-the-ear device (HdO), an in-the-ear device (IdO), an in-the-canal device (complete in the canal, CIC), a pocket device, a headset, a headphone and/or an implant. Hearing aid devices which are improved in this way can in turn be implemented which are essentially immune to the periodic interference signals which are generated by digital telecommunications systems.

The invention has been described above with reference to periodic interference signals in the GSM and DECT telecommunications system. However, it is not restricted to these and comprises, in the same way, periodic interference signals which are generated by other wire-free or wire-bound telecommunications systems. In the same way, the invention is not restricted to mobile telecommunications terminals and hearing aid devices, but rather also comprises, in the same way, other devices which are particularly subjected to such periodic interference signals.

### List of Reference Symbols

1 Signal analyzer

2 Interference suppressor unit

3 Signal synthesizer

4 High-pass filter

5 Low-pass filter

M Signal source

C Interference signal prefilter

F Interference signal suppression device

21 Delay element

22 Multiplier

23 Adder

1. A device for suppressing periodic interference signals, having
a signal analyzer (1) for outputting a fault signal (d(k)) and associated coefficients (aᵢ) on the basis of a useful signal (x(k)) which has been subjected to interference;
an interference suppressor unit (2) for generating a fault signal (d′(k)) which has been subjected to interference suppression and has reduced periodic interference signals on the basis of the fault signal (d(k)); and
a signal synthesizer (3) for recovering a useful signal (x*(k)) which has been subjected to interference suppression, on the basis of the fault signal (d′(k)) which has been subjected to interference suppression, and the coefficients (aᵢ).

2. The device as claimed in patent claim 1, characterized in that the signal analyzer (1) has an FIR filter and/or an IIR filter for outputting a predictive fault signal (d(k)) and associated predictor coefficients (aᵢ) on the basis of a voice signal (x(k)), and the signal synthesizer has an IIR filter and/or FIR filter for recovering the useful signal (x*(k)) which has been subjected to interference suppression, on the basis of a predictive fault signal ((d′(k)) which has been subjected to interference suppression and associated predictor coefficients (aᵢ).

3. The device as claimed in patent claim 1 or 2, characterized in that the signal analyzer (1) has a linear predictor for carrying out a linear prediction.

4. The device as claimed in patent claim 3, characterized in that, the linear predictor (1) carries out a short-term prediction in a time domain of 20 to 400 milliseconds.

5. The device as claimed in one of patent claims 1 to 4, characterized in that the signal analyzer (1) determines the coefficients (aᵢ) by means of a Levinson-Durbin algorithm.

6. The device as claimed in one of patent claims 1 to 5, characterized by a high-pass filter (4) for filtering the useful signal (x(k)) which has been subjected to interference and for improving the coefficient calculation in the signal analyzer (1).

7. The device as claimed in patent claim 6, characterized in that the high-pass filter (4) has a preemphasis filter.

8. The device as claimed in one of patent claims 6 or 7, characterized by a low-pass filter (5) for filtering the useful signal (x*(k)) which has been subjected to interference suppression, and for compensating the high-pass filter (4).

9. The device as claimed in patent claim 8, characterized in that the low-pass filter has a deemphasis filter.

10. The device as claimed in one of patent claims 1 to 9, characterized in that the interference suppressor unit (2) carries out filtering in the time domain or frequency domain.

11. The device as claimed in one of patent claims 1 to 10, characterized in that the interference suppressor unit (2) has a comb filter with maximum attenuation values in each case in the vicinity of the fundamental frequency and the associated harmonics of the periodic interference signals.

12. The device as claimed in one of patent claims 1 to 11, characterized by an interference signal prefilter (C) for reducing the periodic interference signal in the useful signal (x(k)).

13. The device as claimed in one of patent claims 1 to 12, characterized in that the useful signal (x(k)) which has been subjected to interference is generated by an electret microphone.

14. The device as claimed in one of patent claims 1 to 13, characterized in that it is constructed in a wire-free telecommunications terminal.

15. The device as claimed in one of patent claims 1 to 13, characterized in that it is constructed in a hearing aid device.

16. The device as claimed in patent claim 15, characterized in that the hearing aid device constitutes a behind-the-ear device, an in-the-ear device, an in-the-canal device, a pocket device, a headset and/or an implant.

17. The device as claimed in one of patent claims 1 to 16, characterized in that the periodic interference signal constitutes a GSM signal and/or DECT signal and/or Bluetooth signal.

18. A method for suppressing periodic interference signals having the steps:
signal analysis is carried out in order to output a fault signal (d(k)) and associated coefficients (aᵢ) on the basis of a useful signal (x(k)) which has been subjected to interference;
interference suppression is carried out in order to generate a fault signal (d′(k)) which has been subjected to interference suppression and has reduced periodic interference signals on the basis of the fault signal (d(k)); and
a signal synthesis is carried out in order to recover a useful signal (x*(k)) which has been subjected to interference suppression, on the basis of the fault signal (d′(k)) which has been subjected to interference suppression, and the coefficients (aᵢ).

19. The method as claimed in patent claim 18, characterized in that, during the signal analysis, FIR filtering and/or IIR filtering are carried out in order to output a predictive fault signal (d(k)) and associated predictor coefficients (aᵢ) on the basis of a voice signal (x(k)), and the signal synthesis IIR filtering and/or IIR filtering are carried out in order to recover the useful signal (x*(k)) which has been subjected to interference suppression, on the basis of a predictive fault signal (d′(k)) which has been subjected to interference suppression, and the predictor coefficients (aᵢ).

20. The method as claimed in patent claim 18 or 19, characterized in that a linear prediction is carried out during the signal analysis.

21. The method as claimed in patent claim 20, characterized in that the linear prediction constitutes a short-term prediction in a time domain of 20 to 400 milliseconds.

22. The method as claimed in one of patent claims 18 to 21, characterized in that, during the signal analysis, the coefficients (aᵢ) are determined by means of a Levinson-Durbin algorithm.

23. The method as claimed in one of patent claims 18 to 22, characterized by the step of carrying out high-pass filtering in order to filter the useful signal (x(k)) which has been subjected to interference, and in order to improve the coefficient calculation during the signal analysis.

24. The method as claimed in patent claim 23, characterized in that preemphasis filtering is carried out during the high-pass filtering.

25. The method as claimed in one of patent claims 23 or 24, characterized by the further step of low-pass filtering in order to filter the useful signal (x*(k)) which has been subjected to interference suppression, and in order to compensate the high-pass filtering.

26. The method as claimed in patent claim 25, characterized in that deemphasis filtering is carried out during the low-pass filtering.

27. The method as claimed in one of patent claims 18 to 26, characterized in that, during the interference suppression, filtering is carried out in the time domain or frequency domain.

28. The method as claimed in one of patent claims 18 to 27, characterized in that, during the interference suppression, comb filtering is carried out with maximum attenuation values in each case in the vicinity of the fundamental frequency and the associated harmonics of the periodic interference signals.

29. The method as claimed in one of patent claims 18 to 28, characterized by the additional step of carrying out interference signal prefiltering in order to reduce the periodic interference signal in the useful signal (x(k)).

30. The method as claimed in one of claims 18 to 29, characterized in that the useful signal (x(k)) which has been subjected to interference is generated by an electret microphone.

31. The method as claimed in one of patent claims 18 to 30, characterized in that it is carried out in a wire-free telecommunications terminal.

32. The method as claimed in one of patent claims 18 to 30, characterized in that it is carried out in a hearing aid device.

33. The method as claimed patent claim 32, characterized in that the periodic interference signal constitutes a GSM signal and/or DECT signal and/or Bluetooth signal.
